(19) United States
(12) Patent Application Publication
(10) Pub. No.: US 2017/0356412 A1
(43) Pub. Date: Dec. 14, 2017

(54) VALVE MECHANISM AND HIGH-PRESSURE FUEL SUPPLY PUMP INCLUDING VALVE MECHANISM

(71) Applicant: HITACHI AUTOMOTIVE SYSTEMS, LTD., Hitachinaka-shi, Ibaraki (JP)

(72) Inventors: Moritsugu AKIYAMA, Hitachinaka (JP); Shigehiko OMATA, Hitachinaka (JP); Shigenori TAHARA, Hitachinaka (JP); Katsutoshi KOBAYASHI, Tokyo (JP); Kenichirou TOKUO, Hitachinaka (JP)

(73) Assignee: HITACHI AUTOMOTIVE SYSTEMS, LTD., Hitachinaka-shi, Ibaraki (JP)

(21) Appl. No.: 15/540,740

(22) PCT Filed: Jan. 8, 2016
(86) PCT No.: PCT/JP2016/050413

§ 371 Date: Jun. 29, 2017

(30) Foreign Application Priority Data
Jan. 26, 2015 (JP) 2015-011933

(51) Int. Cl. F02M 59/36; F02M 59/44; F02M 59/46

(52) U.S. Cl. CPC F02M 59/36; F02M 59/46; F02M 59/44

(57) ABSTRACT

Provided is a solution to a problem on a discharge valve mechanism disposed at an exit of a pressurizing chamber of a high-pressure fuel supply pump, that is, an occurrence of a backward flow of the fuel concentrates on a limited fuel passage, leading to a higher fuel flow rate, and this easily induces the occurrence of cavitation, and collapse of the generated cavitation might damage a seat surface, making it difficult to maintain valve functions. The present invention provides a valve mechanism including a seat member having a seat section, a valve body configured to attach to or detached from the seat section, and a housing member arranged on an outer peripheral side of the seat member. A first fluid flow-path is formed to connect an inner peripheral side and an outer peripheral side of the seat section in a case where the valve is detached from the seat section. A second fluid flow-path is formed to be connected with the first fluid flow-path, between an outer peripheral surface of the seat member and an inner peripheral surface of the housing member, or between an outer peripheral surface of the valve body and the inner peripheral surface of the housing member. The cross-sectional area along the axial direction of the valve mechanism of the second fluid flow-path is 0.18 mm square or above.

### TECHNICAL FIELD

The present invention relates to a high-pressure fuel supply pump that supplies fuel to an engine with high pressure and particularly relates to a discharge valve mechanism.

### BACKGROUND ART

A known high-pressure fuel pump described in JP 2011-80391 A is provided with a discharge mechanism including a discharge valve member, a valve seat member, a discharge valve spring, and a valve retaining member connected with the valve seat member so as to enclose a seat surface and the discharge valve spring to form a valve storage section inside the valve retaining member.

### CITATION LIST

### Patent Literatures

PTL 1: JP 2011-80391 A

PTL 2: JP 5180365 B2

### SUMMARY OF INVENTION

### Technical Problem

With the configuration of the discharge valve mechanism including the valve retaining member formed to store the valve inside thereof, however, can merely ensure a limited fuel passage as illustrated in 8d of FIG. 13 of JP 2011-80391 A, leading to a problem of a limited flow of fuel due to the limited fuel flow-path. In particular, closing of the valve after completion of discharge causes a pressure difference across the valve leading to a backward flow of once-discharged fuel. At this time, the occurrence of the backward flow concentrates on the limited fuel passage, leading to a higher fuel flow rate at the time of the backward flow. This easily induces cavitation and decay energy of the generated cavitation might damage the seat surface, making it difficult to maintain the valve functions.

The object of the present invention is to provide a high-quality valve mechanism capable of preventing the occurrence of damage in the valve function, and provide a high-pressure fuel supply pump including the same valve mechanism.

### Solution to Problem

In order to achieve the above-described object, the present invention provides a valve mechanism including a seat member having a seat section, a valve body to be attached to or detached from the seat section, and a housing member arranged on an outer peripheral side of the seat member. In this, a first fluid flow-path is formed to connect an inner peripheral side and an outer peripheral side of the seat section in a case where the valve body is detached from the seat section, a second fluid flow-path is formed to be connected with the first fluid flow-path, between an outer peripheral surface of the seat member and an inner peripheral surface of the housing member, or between an outer peripheral surface of the valve body and the inner peripheral surface of the housing member. The cross-sectional area along the axial direction of the valve mechanism of the second fluid flow-path is determined to be 0.18 mm square or above.

### Advantageous Effects of Invention

According to the present invention configured as above, the fuel flows backwards along a first fuel passage and a second fuel passage when the once-discharged fuel flows backwards due to the occurrence of the pressure difference across the valve, making it possible to reduce the flow rate of the fuel at the time of the backward flow. This can suppress the occurrence of cavitation and damage in the seat surface due to cavitation collapse, making it possible to enhance the quality of the valve functions.

### BRIEF DESCRIPTION OF DRAWINGS

FIG. 1 is an exemplary fuel supply system using a high-pressure fuel supply pump according to a first exemplary embodiment of the present invention.

FIG. 2 is a longitudinal cross-sectional view of a discharge process of a discharge valve mechanism according to the first exemplary embodiment of the present invention.

FIG. 3 is a longitudinal cross-sectional view of an intake process of a discharge valve mechanism according to the first exemplary embodiment of the present invention.

FIG. 4 is a cross-sectional view of the discharge valve mechanism when the valve is open, according to the first exemplary embodiment of the present invention.

FIG. 5 is an enlarged view of the discharge valve mechanism when the valve is open, illustrating a fluid flow-path, according to the first exemplary embodiment of the present invention.

FIG. 6 is a cross-sectional view of a discharge valve mechanism when the valve is closed, for explaining an object of the present invention.

FIG. 7 is a transverse cross-sectional view of discharge valve mechanism, illustrating the flow of fuel at backward flow, for explaining the object of the present invention.

FIG. 8 is a transverse cross-sectional view of discharge valve mechanism, illustrating the flow of fuel at backward flow, according to the first exemplary embodiment of the present invention.

FIG. 9 is a graph illustrating a relationship between the cross-sectional area of a fuel passage and damage in the seat section due to cavitation.

FIG. 10 is an exploded perspective view of the discharge valve mechanism according to the first exemplary embodiment of the present invention.

FIG. 11 is a longitudinal cross-sectional view of a discharge valve mechanism according to a second exemplary embodiment of the present invention.

### DESCRIPTION OF EMBODIMENTS

Hereinafter, exemplary embodiments of the present invention will be described with reference to the drawings.

### Exemplary Embodiment 1

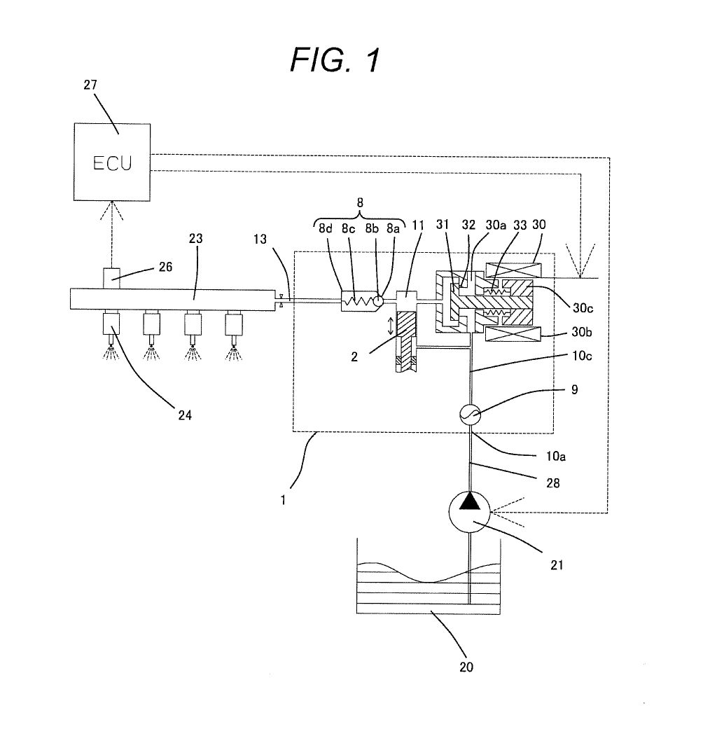

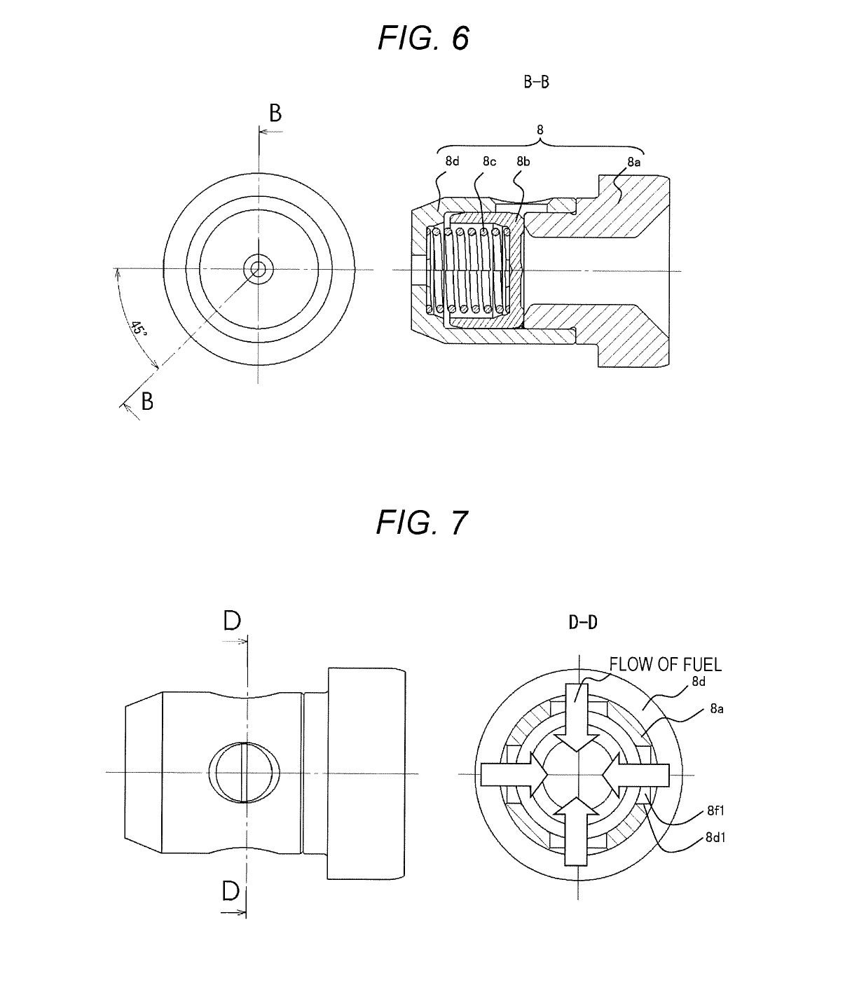

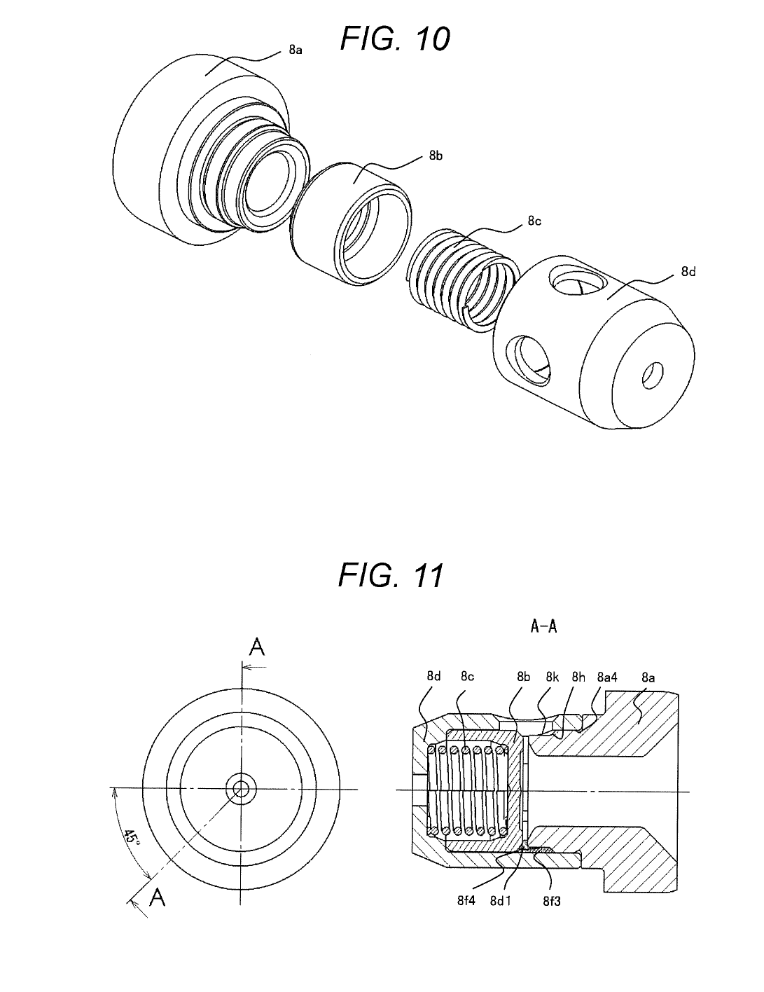

Hereinafter, a configuration and operation of a high-pressure fuel supply pump according to a first embodiment of the present invention will be described with reference to FIGS. 1 to 11.

First, a configuration of a high-pressure fuel supply system that uses the high-pressure fuel supply pump according to the present embodiment will be described with reference to FIG. 1.

FIG. 1 is a general configuration of the high-pressure fuel supply system that uses the high-pressure fuel supply pump according to the first embodiment of the present invention.

In FIG. 1, a portion surrounded by a broken line indicates a pump housing 1 of the high-pressure fuel supply pump, with mechanisms and components indicated within this broken line being incorporated into the pump housing 1, so as to constitute the high-pressure fuel supply pump of the present embodiment. Moreover, dotted lines in the diagram indicate flows of electrical signals.

The fuel in a fuel tank 20 is pumped up by a feed pump 21, then, fed to a fuel inlet 10a of the pump housing 1 via an intake pipe 28. The fuel that passes through the fuel inlet 10a reaches an intake port 30a of an electromagnetic intake valve mechanism 30 constituting a variable displacement mechanism, via a pressure pulsation reduction mechanism 9 and an intake passage 10c.

The electromagnetic intake valve mechanism 30 includes an electromagnetic coil 30b. In a state where the electromagnetic coil 30b is energized, an electromagnetic plunger 30c compresses a spring 33 to come to a state of being moved to the left as illustrated in FIG. 1, and this state is maintained. At this time, an intake valve body 31 attached on an end of the electromagnetic plunger 30c opens an inlet 32 that communicates with a pressurizing chamber 11 of the high-pressure fuel supply pump. When the electromagnetic coil 30b is not energized and there is no fluid differential pressure between the intake passage 10c (intake port 30a) and the pressurizing chamber 11, biasing force of the spring 33 biases the intake valve body 31 in a valve closing direction (right direction in FIG. 1), so as to put the inlet 32 into a closed state, and this state is maintained. FIG. 1 illustrates a state where the inlet 32 is closed.

A plunger 2 is retained in the pressurizing chamber 11, slidably in the up-down direction in FIG. 1. When the plunger 2 is displaced downward in FIG. 1 being in a state of an intake process due to rotation of a cam in an internal combustion engine, the volume of the pressurizing chamber 11 is increased and the fuel pressure therein is decreased. In this process, when the fuel pressure within the pressurizing chamber 11 is decreased below the pressure of the intake passage 10c (intake port 30a), valve opening force due to fluid differential pressure of the fuel (force to displace the intake valve body 31 leftward in FIG. 1) is generated on the intake valve body 31. Due to this valve opening force, the intake valve body 31 overcomes the biasing force of the spring 33 and opens the valve, then, opens the inlet 32. In this state, when a control signal from an ECU 27 is applied to the electromagnetic intake valve mechanism 30, an electric current flows through the electromagnetic coil 30b of the electromagnetic intake valve 30, and then, magnetic biasing force moves the electromagnetic plunger 30c leftward in FIG. 1, so as to maintain the inlet 32 in an open state.

The plunger 2 is transitioned from the intake process to the compression process (rising process from a lower start point to an upper start point) while application of input voltage is maintained on the electromagnetic intake valve mechanism 30. At this time, the magnetic biasing force is maintained since an energization state of the electromagnetic coil 30b is maintained, and thus, the intake valve body 31 continuously maintains the open state of the valve. While the volume of the pressurizing chamber 11 decreases together with a compression movement of the plunger 2, the fuel once taken into the pressurizing chamber 11 passes again through a portion between the intake valve body 31 in the valve-open state and the inlet 32, and returns to the intake passage 10c (intake port 30a). Accordingly, there is no increase in the pressure of the pressurizing chamber 11. This process is referred to as a return process.

When energization of the electromagnetic coil 30b is stopped in the return process, the magnetic biasing force working on the electromagnetic plunger 30c is eliminated after a predetermined time (magnetic and mechanical delay time). Consequently, the biasing force of the spring 33 constantly working on the intake valve body 31, and fluid force generated by pressure loss of the inlet 32 causes the intake valve body 31 to move rightward in FIG. 1, so as to close the inlet 32. From the point on which the inlet 32 is closed, the fuel pressure within the pressurizing chamber 11 increases with the rise of the plunger 2. Subsequently, when the fuel pressure within the pressurizing chamber 11 exceeds a pressure that is greater than the fuel pressure at the outlet 13 by a predetermined value, the fuel remaining in the pressurizing chamber 11 is discharged under high pressure via a discharge valve unit (discharge valve mechanism) 8, and supplied to the common rail 23. This process is referred to as a discharge process. As described above, the compression process of the plunger 2 includes the return process and the discharge process.

While pressure pulsation occurs on the intake passage due to the fuel returned to the intake passage 10c during the return process, the pressure pulsation occurs as a slight backward flow from the inlet 10a to the intake pipe 28. Most portion of the returned fuel is absorbed by the pressure pulsation reduction mechanism 9.

The ECU 27 controls the timing of de-energization of the electromagnetic coil 30c of the electromagnetic intake valve mechanism 30, thereby enabling the control of the amount of discharged high-pressure fuel. When the timing of de-energization of the electromagnetic coil 30b is advanced, the ratio of the return process among the compression process is decreased while the ratio of the discharge process among the compression process is increased. That is, the fuel returned to the intake passage 10c (intake port 30a) is decreased, and the discharged fuel with high-pressure is increased. In contrast, when the above-described timing of de-energization is delayed, the ratio of the return process among the compression process is increased while the ratio of the discharge process among the compression process is decreased. That is, the fuel returned to the intake passage 10c is increased, and the discharged fuel with high-pressure is decreased. The above-described de-energization timing is controlled by an instruction from the ECU 27.

As described above, the ECU 27 controls the timing of de-energization of the electromagnetic coil, thereby enabling discharging the fuel with high pressure in the amount needed by the internal combustion engine.

Within the pump housing 1, the discharge valve unit (discharge valve mechanism) 8 is provided between an exit side of the pressurizing chamber 11 and the outlet (discharge-side piping connection portion) 13. The discharge valve unit (discharge valve mechanism) 8 includes a valve seat member 8a, a discharge valve member 8b, a discharge valve spring 8c, and a valve retaining member 8d. In a state where there is no fuel differential pressure between the pressurizing chamber 11 and the outlet 13, the discharge valve member 8b is press-bonded to the valve seat member 8a due to the biasing force by the discharge valve spring 8c and in a valve-closed state. When the fuel pressure within the pressurizing chamber 11 exceeds the pressure that is greater than the fuel pressure at the outlet 13 by a predetermined value, the discharge valve member 8b opens against the discharge valve spring 8c, then, the fuel within the pressurizing chamber 11 is discharged to the outlet 13 via the discharge valve unit (discharge valve mechanism) 8.

The discharge valve member 8b opens the valve, and thereafter, comes in contact with a stopper 805 formed on the valve retaining member 8d, whereby, the operation of the discharge valve member 8b is limited. Therefore, the stroke of the discharge valve member 8b is appropriately determined by the valve retaining member 8d.

Moreover, when the discharge valve member 8b repeats valve opening motion and valve closing motion, an inner wall 806 of the valve retaining member 8d guides the motion to enable the motion to be done smoothly in the stroke direction. By the above-described configuration, the discharge valve unit (discharge valve mechanism) 8 operates as a check valve for limiting the flow direction of the fuel. Note that details of the configuration of the discharge valve unit (discharge valve mechanism) 8 will be described below with reference to FIGS. 2 to 5, FIG. 7, and FIG. 11.

As described above, the fuel directed to the fuel inlet 10a is pressurized to a high pressure by a needed amount within the pressurizing chamber 11 of the pump housing 1 by reciprocation of the plunger 2, and then, pumped from the outlet 13 to the common rail 23 as a high-pressure pipe, via the discharge valve unit (discharge valve mechanism) 8.

Hereinabove, an exemplary case where a normal-closed electromagnetic valve configured to be closed at a time of non-energization and opens at a time of energization has been described. In contrast, it is also allowable to use an normal-open electromagnetic valve configured to be open at a time of non-energization and closed at a time of energization. In this case, ON and OFF are reversed with each other in a flow control command from the ECU 27.

An injector 24 and a pressure sensor 26 are attached on the common rail 23. The injector 24 is attached in accordance with the number of cylinders. The injector 24 performs open/close operation and injects a predetermined amount of fuel into the cylinder in accordance with the control signal from the ECU 27.

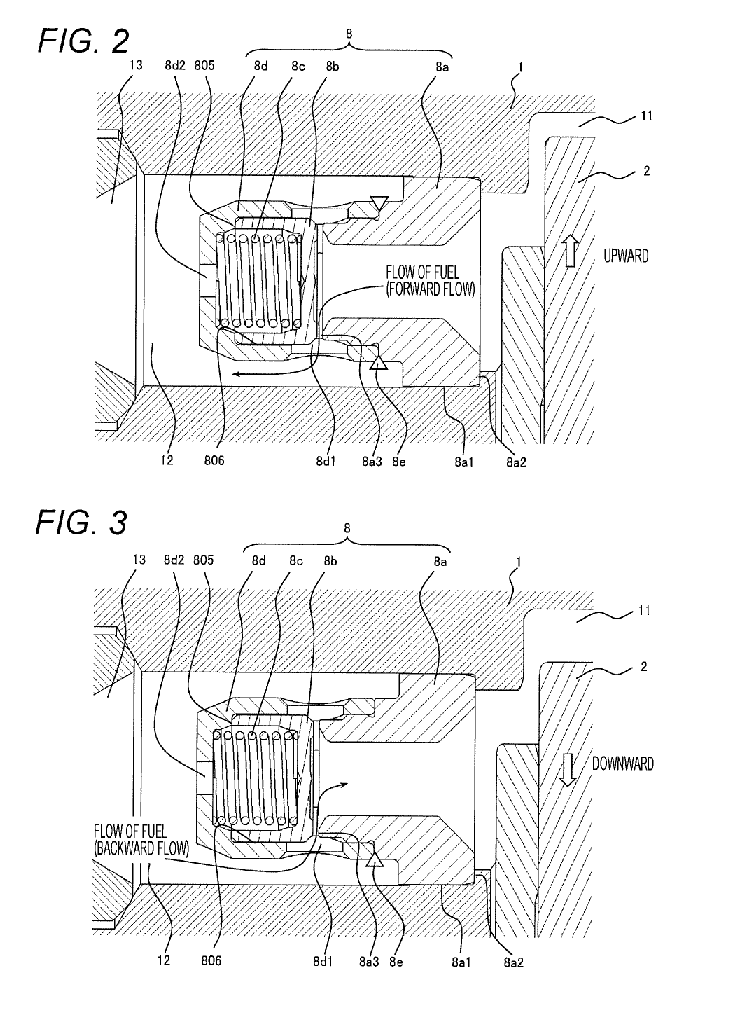

Next, the configuration of the discharge valve unit (discharge valve mechanism) 8 used in the high-pressure fuel supply pump according to the present embodiment will be described with reference to FIGS. 2 and 3.

FIG. 2 is an enlarged view of the discharge valve mechanism portion (compression process state).

FIG. 3 is an enlarged view of the discharge valve mechanism portion (intake process state).

The discharge valve unit (discharge valve mechanism) 8 is provided at an exit of the pressurizing chamber 11. The discharge valve unit (discharge valve mechanism) 8 includes the valve seat member 8a, the discharge valve member 8b, the discharge valve spring 8c, and the valve retaining member 8d as a discharge valve stopper. First, the discharge valve unit (discharge valve mechanism) 8 is assembled outside the pump housing 1 by performing laser welding onto a weld portion 8e, and thereafter, the assembled discharge valve unit (discharge valve mechanism) 8 is press-fit into the pump housing 1 and fixed at a press-fit portion 8a1. When the press-fitting is performed, attachment jig is applied to a load receiving portion 8a2 formed as a stepped surface larger than the weld portion 8e in diameter, and force is applied to the right side in the figure, so as to perform press-fitting and fixing onto the pump housing 1.

A passage 8d2 is provided at a discharge-side end of the valve retaining member 8d. Therefore, in a state where there is no fuel differential pressure between the pressurizing chamber 11 and the outlet 12 on the discharge valve unit (discharge valve mechanism) 8, the discharge valve member 8b is pressed against a seat surface portion 8a3 of the valve seat member 8a by the biasing force of the discharge valve spring 8c, in a seated state (valve-closed state). When the fuel pressure within the pressurizing chamber 11 exceeds the fuel pressure at the outlet 12, that is, when it increases to the valve opening pressure of the discharge valve spring 8c, or above, the discharge valve member 8b opens against the discharge valve spring 8c, as illustrated in FIG. 2, and then, the fuel within the pressurizing chamber 11 is discharged to the common rail 23 via the outlet 12. At this time, the fuel passes through a single or a plurality of passages 8d1 provided on the valve retaining member 8d and is pumped from the pressurizing chamber 11 to the outlet 12. Thereafter, when the sum of the fuel pressure at the outlet 12 and the valve opening pressure of the discharge valve spring 8c exceeds the fuel pressure within the pressurizing chamber 11, the discharge valve member 8b returns to the initial closed state. With this configuration, it is possible to close the discharge valve member 8b after discharging the high-pressure fuel.

Note that the valve opening pressure of the discharge valve member 8b is set to 0.1 MPa or below. As described above, the feed pressure is 0.4 MPa, and the discharge valve member 8b is opened by the feed pressure. With this configuration, even in a case where high-pressure application of the fuel is disabled due to a failure of the high-pressure fuel supply pump, or the like, the fuel is supplied to the common rail with the feed pressure, enabling the injector 24 to inject the fuel.

When the discharge valve member 8b opens the valve, the discharge valve member 8b comes in contact with a stopper 805 provided on an inner peripheral portion of the valve retaining member 8d, whereby the operation of the discharge valve member 8b is limited. Accordingly, the stroke of the discharge valve member 8b is appropriately determined with a step formed by the stopper 805 provided at the inner peripheral portion of the valve retaining member 8d. Moreover, when the discharge valve member 8b repeats valve opening motion and valve closing motion, the inner peripheral surface 806 of the valve retaining member 8d guides the motion such that the discharge valve member 8b moves solely in the stroke direction.

With the above-described configuration, the discharge valve unit (discharge valve mechanism) 8 operates as a check valve for limiting the flow direction of the fuel.

Next, characteristic configuration of the discharge valve unit (discharge valve mechanism) 8 according to the present embodiment will be described.

In the present exemplary embodiment, with respect to the movement direction of the discharge valve member 8b in a case where the discharge valve member 8b is detached from the valve seat member 8a, a fluid flow-path on which the fuel passes toward an inner peripheral side and an outer peripheral side of the valve seat member 8a, and further passes through the passage 8d1 provided on the valve retaining member 8d among the passage of the fuel pumped from the pressurizing chamber 11 to the outlet 12, is defined as a first fluid flow-path 8f1, and a fluid flow-path for the fuel that flows from the inner peripheral side to the outer peripheral surface of the valve seat member 8a, and that is connected with the first fluid flow-path 8f1 at a portion formed with the inner peripheral wall of the valve retaining member 8d, or between the outer peripheral surface of the discharge valve member 8b and the inner peripheral wall of the valve retaining member 8d, is defined as a second fluid flow-path 8f2. The fuel is compressed within the pressurizing chamber 11 together with the rise of the plunger 2, and when the fuel pressure within the pressurizing chamber 11 exceeds the fuel pressure of the outlet 12, that is, when the fuel pressure increases to the valve opening pressure by the discharge valve spring 8c, or above, the discharge valve member 8b opens against the discharge valve spring 8c as illustrated in FIG. 2. Subsequently, the fuel within the pressurizing chamber 11 passes through the first fluid flow-path 8f1, the second fluid flow-path 8f2, and the outlet 12, and then, is discharged to the common rail 23.

Thereafter, when the sum of the fuel pressure at the outlet 12 and the valve opening pressure of the discharge valve spring 8c exceeds the fuel pressure within the pressurizing chamber 11, the discharge valve member 8b returns to the initial closed state. While this enables closing of the discharge valve member 8b after discharging high-pressure fuel, the fuel pressure within the pressurizing chamber 11 is decreased due to the movement of the plunger 2 that has transitioned from the compression process to the intake process during the valve closing operation. This leads to the state where the fuel pressure at the outlet 12>the fuel pressure of the pressurizing chamber 11. This causes the high-pressure fuel to flow backwards to the low-pressure pressurizing chamber 11 in a process of closing of the discharge valve member 8b after discharging high-pressure fuel (FIG. 3).

This backward flow continues until the discharge valve member 8b is closed completely after discharge of high-pressure fuel. The flow rate of this backward flow is maximized immediately before complete closing of the valve. The increase in the flow rate of the fuel reduces the pressure of the fuel, and when the pressure reaches a saturated vapor pressure, cavitation is generated. When the decreased fuel pressure around the cavitation recovers to the saturated vapor pressure or above, the generated cavitation collapses with a great amount of decay energy. When the cavitation collapse occurs in the neighborhood of the valve seat member 8a and the discharge valve member 8b, this would damage the valve seat member 8a and the discharge valve member 8b. In the worst case, repeated occurrence of cavitation collapse would damage the seat surface 8a3 formed between the valve seat member 8a and the discharge valve member 8b facing each other and would disable closing of the valve. This would disable the function as a check valve of limiting the flow direction of the fuel of the discharge valve unit (discharge valve mechanism) 8.

Achieving reduction of the flow rate of the backward flow would suppress the generation of cavitation, leading to achieving suppression of the damage in the seat surface due to cavitation collapse, making it possible to maintain the function as a check valve of limiting the flow direction of the fuel of the discharge valve unit (discharge valve mechanism) 8.

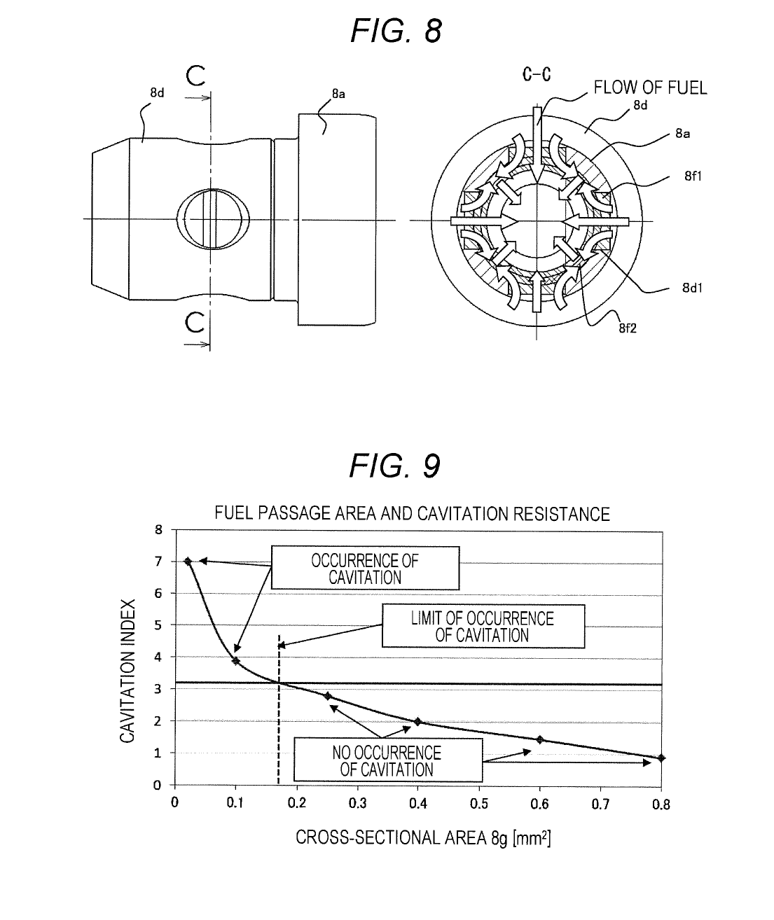

Now, the flow of fuel at backward low at a known discharge valve portion mechanism described in JP 2011-80391 A will be illustrated with reference to FIG. 7, and the flow of fuel at backward low at the discharge valve unit (discharge valve mechanism) 8 according to the present embodiment will be illustrated with reference to FIG. 8.

FIG. 7 illustrating a known discharge valve portion mechanism is a cross-sectional view taken along the seat surface 8a3 that is orthogonal to a stroke axis of the discharge valve member 8b of the discharge valve unit (discharge valve mechanism) 8 and formed when the valve seat member 8a and the discharge valve member 8b face with each other when the valve is closed. The fuel that flows backwards from the outlet 12 to the pressurizing chamber 11 can only be flown backwards through the fluid flow-path 8f1 that passes through the passage 8d1 provided on the valve retaining member 8d. This causes the fuel that flows backwards to be concentrated at the fluid flow-path 8f1, leading to a higher flow rate. Consequently, the backwards flowing fuel reaches a pressure that is the above-described saturated vapor pressure or below and this generates cavitation. When cavitation collapse occurs, the valve seat member 8a and the discharge valve member 8b would be damaged.

In contrast, FIG. 8 illustrating a discharge valve portion mechanism according to the present embodiment is a cross-sectional view taken along the seat surface 8a3 that is orthogonal to a stroke axis of the discharge valve member 8b of the discharge valve unit (discharge valve mechanism) 8 and formed when the valve seat member 8a and the discharge valve member 8b face with each other when the valve is closed. The fuel that flows backwards from the outlet 12 toward the pressurizing chamber 11 can flow backwards from a full circumference of 360° including the fluid flow-path 8f1 that passes through the passage 8d1 provided on the valve retaining member 8d and the second fluid passage 8f2. Accordingly, the fuel that flows backwards can flow evenly without causing the backward flow to be concentrated on the backward fluid flow-path 8f1 on the known discharge valve mechanism illustrated in FIG. 7, making it possible to suppress an increase in the flow rate. This leads to suppression of the occurrence of cavitation and suppression of the damage on the seat surface due to cavitation collapse, making it possible to maintain the function of a check valve of limiting the flow direction of the fuel in the discharge valve unit (discharge valve mechanism) 8.

As described above, the valve mechanism according to the present exemplary embodiment includes the seat member 8a having the seat section (seat surface 8a3), the valve body (discharge valve member 8b) that is attached to or detached from the seat surface 8a3, and the housing member (valve retaining member 8d) arranged on the outer peripheral side of the seat member 8a. Moreover, the first fluid flow-path (fluid flow-path 8f1) connecting the inner peripheral side and the outer peripheral side of the seat section (seat surface 8a3) is formed in a case where the valve body (discharge valve member 8b) is detached from the seat section (seat surface 8a3), and the second fluid flow-path 8f2 connected with the first fluid flow-path (fluid flow-path 8f1) is formed between the outer peripheral surface of the seat member 8a and the inner peripheral surface of the housing member (valve retaining member 8d) or between the outer peripheral surface of the valve body (discharge valve member 8b) and the inner peripheral surface of the housing member (valve retaining member 8d). In addition, the present exemplary embodiment is characterized by having a cross-sectional area of the second fluid flow-path 8f2 along the axial direction of the valve mechanism is 0.18 square mm or above.

The horizontal axis of FIG. 9 indicates a cross-sectional area 8g of the second fluid flow-path 8f2 along the axial direction of the valve mechanism, as a variable, and the vertical axis of FIG. 9 indicates a cavitation occurrence index. The cavitation index represents an index obtained by fluid analysis. The greater the cavitation index, the more likely the cavitation occurs. The cross-sectional area 8g of the second fluid flow-path 8f2 along the axial direction of the valve mechanism indicates that it is possible to suppress the occurrence of cavitation by setting the size preferably to 0.18 square mm or above.

Note that, in the present exemplary embodiment, a flow-path area 8i at a time of the maximum stroke of the discharge valve member 8b at an entrance of the housing member (valve retaining member 8d) of the first fluid flow-path 8f1 is 0.29 square mm. The flow-path area 8i is defined as the area of a cross-section obtained by projecting the cross-section of the fluid flow-path 8f1 to the passage 8d1 of the valve retaining member 8d, when the fluid flow-path 8f1 is viewed from the side surface (lower side of FIG. 5) in a state where the stroke of the discharge valve member 8b is at the maximum in FIG. 5. That is, the both sides of the cross-section of the fluid flow-path 8f1, facing with each other, are constituted with a portion of the passage 8d1 of the valve retaining member 8d. Moreover, another set of both sides is constituted with the seat surface 8a3 and its opposing attachment surface of the discharge valve member 8b. In comparison of this with the cross-sectional area 8g, it is preferable that the above-described cross-sectional area 8g of the second fluid flow-path 8f2 is ⅔ times or more of the above-described flow-path area 8i of the first fluid flow-path 8f1. In the present exemplary embodiment, the passage 8d1 of the valve retaining member 8d is provided in plural and in a form of circle, and the cross-sectional area (fluid flow-path area) of the passage 8d1 in the flow direction is 1.89 square mm. The passage 8d1 of the valve retaining member 8d is the passage as illustrated in FIG. 3, in which a tapered surface is not considered. In comparison of this with the cross-sectional area 8g, the above-described cross-sectional area 8g of the second fluid flow-path 8f2 is formed to be 1/10 times or more of the fluid flow-path area of the passage 8d1 of the valve retaining member 8d. This makes it possible to suppress the occurrence of the above-described cavitation.

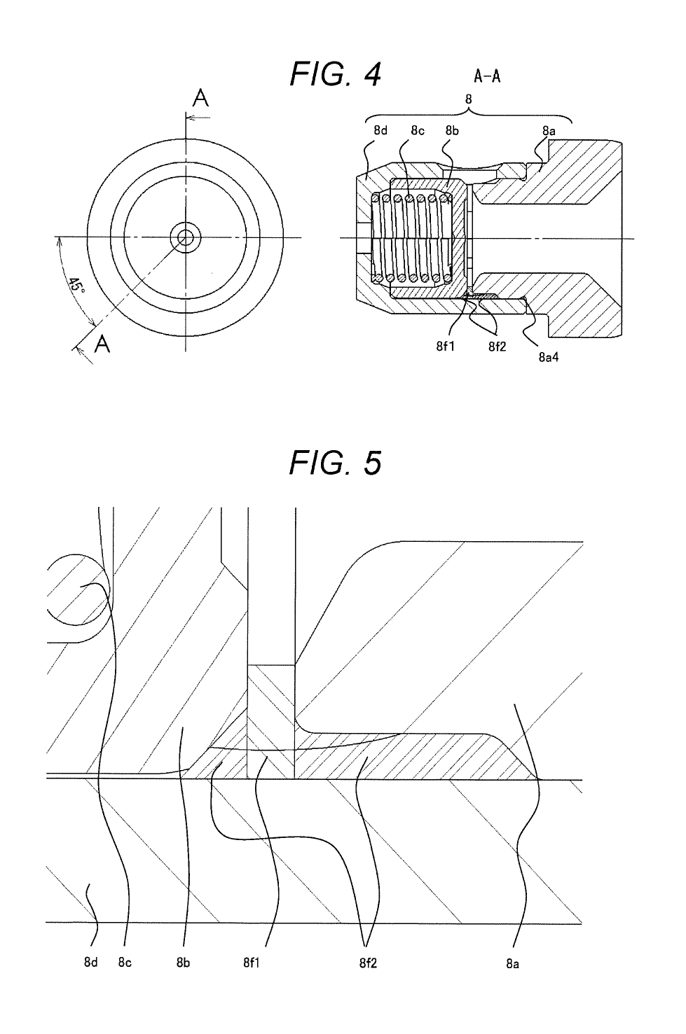

Moreover, as illustrated in a hatched portion in the right diagram in FIG. 4, the cross-sectional area 8g of the second fluid flow-path 8f2 includes the outer peripheral surface of the seat member 8a, the outer peripheral surface of the discharge valve member 8b, and the inner peripheral surface of the valve retaining member 8d. The cross-sectional area 8g of the second fluid flow-path 8f2 is formed with a seat member-side cross-sectional area and a discharge valve member-side cross-sectional area. Specifically, the seat member-side cross-sectional area includes the outer peripheral surface of the valve seat member 8a, the inner peripheral surface of the valve retaining member 8d, and an extension line extending in an outer peripheral direction, that is perpendicular to the axial direction, from the seat section, and is formed along the axial direction. Moreover, the discharge valve member-side cross-sectional area is constituted with the outer peripheral surface of the discharge valve member 8b, the inner peripheral surface of the valve retaining member 8d, and the above-described extension line, and is formed along the axial direction. In the present exemplary embodiment, the seat member-side cross sectional area is supposed to be greater than the discharge valve member-side cross sectional area. This enables ensuring the cross-sectional area of the second fluid flow-path 8f2 merely by the seat member side, and enables downsizing of the discharge valve member-side cross sectional area for the opening/closing portion. Moreover, it is possible to ensure the sliding length on the outer peripheral surface of the discharge valve member 8b with the valve body retaining member 8d, and thus to suppress inclination of the discharge valve member 8b, leading to achievement of smooth opening/closing of the valve.

Note that the size of the seat member-side cross sectional area in the axial direction is preferably greater than the size of the discharge valve member-side cross sectional area in the axial direction. Moreover, the second fluid flow-path 8f2 is preferably formed on the outer peripheral side of the valve seat member 8a, or preferably formed at a full circumference of the outer peripheral side of the discharge valve body 8b. A cylinder is provided within the pressurizing chamber 11, and the second fluid flow-path 8f2 is arranged so as to span an upper end portion of the cylinder in a piston motion direction within the pressurizing chamber 11.

In the present exemplary embodiment, a stepped portion 8a4 is formed on the outer peripheral side of the valve seat member 8a. The stepped portion 8a4 is a recess that is recessed toward the inside, on the inner peripheral side opposite to the side of the discharge valve body 8b. Moreover, a gap is formed between the recess and the housing member, thereby forming the second fluid flow-path 8f2. This stepped portion 8a4 allows the valve body retaining member to be inserted without riding on the seat member, making possible to enhance the valve unit assembly efficiency.

### Exemplary Embodiment 2

A second exemplary embodiment of the present invention will be described with reference to FIG. 11.

The function of the discharge valve mechanism has been described in Exemplary Embodiment 1, therefore, description thereof will be omitted.

In a configuration in which the valve body housing 8d is attached to the seat member 8A in JP 5180365 B2, there is a gap (buffer) between the outer peripheral surface of the seat member 8A and the valve body housing 8d.

This, however, has an assembly efficiency problem in that the valve body housing 8d might bump a right-angled stepped portion of the seat member 8A when the valve body housing 8d is attached to the seat member 8A.

In the present exemplary embodiment, a seat member slope 8h is formed on the outer peripheral surface of the valve seat member 8a. The seat member slope 8h is formed to expand toward the outer peripheral side, in a direction from the discharge valve member 8b toward the seat member 8a. A gap is formed between the seat member slope 8h and the housing member (valve retaining member 8d). With the slope expanding toward the outer peripheral side, being formed on the outer peripheral surface of the valve seat member 8a, it is possible to soften the impact at a time of attaching the valve retaining member 8d to the valve seat member 8a, and to enhance the assembly efficiency. Moreover, the slope leads to formation of a second fluid flow-path 8f3 between the outer peripheral surface of the valve seat member 8a and the valve retaining member 8d. Accordingly, the fuel that flows backwards from the exit 12 toward the pressurizing chamber 11 can flow backwards from a full circumference of 360° including a flow-path 8f4 that passes through the passage 8d1 provided on the valve retaining member 8d and the second fluid flow-path 8f3. Accordingly, the fuel that flows backwards can flow evenly without causing the backward flow to be concentrated on the backward fluid flow-path 8f1 on the known discharge valve mechanism illustrated in FIG. 7, making it possible to suppress an increase in the flow rate. This leads to suppression of the occurrence of cavitation and suppression of damage on the seat surface due to cavitation collapse, making it possible to maintain the function of a check valve of limiting the flow direction of the fuel in the discharge valve unit (discharge valve mechanism) 8.

On the outer peripheral surface of the valve seat member 8a, a flat portion is formed on a portion closer to the discharge valve member 8b than the seat member slope. The flat portion is substantially parallel to the inner peripheral surface of the valve body retaining member 8d. This makes it possible to ensure the size of the second fluid flow-path 8f3 formed between the flat portion and the valve body retaining member 8d. Accordingly, the fuel that flows backwards from the exit 12 to the pressurizing chamber 11 can flow backwards from a full circumference of 360° including the fluid flow-path 8f4 that passes through the passage 8d1 provided on the valve retaining member 8d and the second fluid passage 8f3. Accordingly, the fuel that flows backwards can flow evenly without causing the backward flow to be concentrated on the backward fluid flow-path 8f1 on the known discharge valve mechanism illustrated in FIG. 7, making it possible to suppress an increase in the flow rate. This can suppress the occurrence of cavitation and ultimately suppress the damage of the seat surface due to cavitation collapse. Furthermore, it is possible to maintain the function as a check valve of limiting the flow direction of the fuel of the discharge valve unit (discharge valve mechanism) 8.

Furthermore, the discharge valve body 8b illustrated in FIG. 11 is configured to have a valve body slope to be expanding from the valve seat member 8a toward the outer peripheral side along the direction toward the discharge valve body 8b on the outer peripheral side of the contact surface with the valve seat member 8a. This configuration forms a gap between the valve body slope and the valve body retaining member 8d. Moreover, the slope angle formed between the seat surface and the both ends of the valve seat member slope is made to be greater than the inclination angle formed between the seat surface and the end portion of the discharge valve body slope. With this configuration, a space is formed also on the discharge valve body side, making it possible to further expand the size of the second fluid flow-path 8f3. Accordingly, the fuel that flows backwards from the exit 12 to the pressurizing chamber 11 can flow backwards from a full circumference of 360° including the fluid flow-path 8f1 that passes through the passage 8d1 provided on the valve retaining member 8d and the second fluid passage 8f3.

Accordingly, the fuel that flows backwards can flow evenly without causing the backward flow to be concentrated on the backward fluid flow-path 8f1 on the known discharge valve mechanism illustrated in FIG. 7, making it possible to suppress an increase in the flow rate. This makes it possible to suppress the generation of cavitation, leading to ultimate suppression of the damage in the seat surface 8a3 due to cavitation collapse, or makes it possible to maintain the function as a check valve of limiting the flow direction of the fuel of the discharge valve unit (discharge valve mechanism) 8. In addition, the inclination angle is formed to be smaller than the valve seat member slope, and thus, it is possible to ensure the sliding length of the outer peripheral surface of the discharge valve member 8b and the valve body retaining member 8d, and to suppress inclination of the discharge valve member 8b, leading to achievement of smooth opening/closing of the valve.

Moreover, in the present exemplary embodiment as illustrated in FIG. 11, on the outer peripheral surface of the valve seat member 8a, a flat portion 8k is formed on a portion opposite to the discharge valve body 8b, more than the valve seat member slope 8h. The flat portion 8k is substantially parallel to the inner peripheral surface of the valve body retaining member 8d. With this configuration, the valve body retaining member 8d comes in contact with the flat portion 8k, thereby making it possible to retain the valve seat member 8a.

Moreover, the outer peripheral surface of the valve seat member 8a is recessed toward the inner peripheral side, on the opposite side of the valve body across the flat portion to form a stepped portion 8a4, and a gap is formed between the stepped portion 8a4 and the valve body retaining member 8d. Accordingly, when the valve body retaining member 8d is assembled to the valve seat member 8a, it is possible to suppress riding of the valve body retaining member 8d onto the valve seat member 8a (FIG. 11).

Even when the valve seat member slope is formed to be inclined to the outer peripheral side from the end portion of the flat portion of the valve seat section, it is possible to achieve an effect similar to the effects of the present exemplary embodiment. Note that the seat member slope is preferably formed in a tapered shape. While the exemplary embodiments of the present invention have been described as above, by combining the configurations described in Exemplary Embodiments 1 and 2, it is possible to synergistically obtain the effects that would be obtained by individual exemplary embodiments.

### REFERENCE SIGNS LIST

1 pump housing
2 plunger
8 discharge valve unit (discharge valve mechanism)
8a valve seat member
8b discharge valve member
8c discharge valve spring
8d valve retaining member
8e weld portion
8g cross-sectional area of second fluid flow-path
8h slope
8i flow-path area at entrance of valve retaining member 8d of first fluid flow-path 8f1
8k flat portion
8a1 press-fit portion
8a2 load receiving portion
8a3 seat surface portion
8a4 stepped portion
8d1 passage provided on valve body retaining member
8f1 first fluid flow-path
8f2 second fluid flow-path
8f3 fluid flow-path on valve seat member side
8f4 fluid flow-path on discharge valve member side pressure pulsation reduction mechanism
10c intake passage
11 pressurizing chamber
13 outlet
20 fuel tank
23 common rail
24 injector
26 pressure sensor
27 ECU
30 electromagnetic intake valve mechanism
805 stopper
806 inner wall of valve body retaining member

1. A valve mechanism comprising:
a seat member having a seat section;
a valve body configured to attach to or detached from the seat section; and
a housing member arranged on an outer peripheral side of the seat member,
wherein a first fluid flow-path is formed to connect an inner peripheral side with an outer peripheral side of the seat section in a case where the valve body is detached from the seat section, a second fluid flow-path is formed to be connected with the first fluid flow-path, between an outer peripheral surface of the seat member and an inner peripheral surface of the housing member, or between an outer peripheral surface of the valve body and the inner peripheral surface of the housing member, and
a cross-sectional area along the axial direction of the valve mechanism of the second fluid flow-path is 0.18 mm square or above.

2. A valve mechanism comprising:
a seat member having a seat section;
a valve body configured to attach to or detached from the seat section; and
a housing member arranged on an outer peripheral side of the seat member,
wherein a first fluid flow-path is formed to connect an inner peripheral side and an outer peripheral side of the seat section in a case where the valve body is detached from the seat section,
a second fluid flow-path is formed to be connected with the first fluid flow-path, between an outer peripheral surface of the seat member and an inner peripheral surface of the housing member, or between an outer peripheral surface of the valve body and the inner peripheral surface of the housing member, and
the cross-sectional area of the second fluid flow-path becomes ⅔ times or more of the fluid flow-path area of the first fluid flow-path, in a state where a stroke of the valve body is at the maximum.

3. The valve mechanism according to claim 1,
wherein the cross-sectional area of the second fluid flow-path includes the outer peripheral surface of the seat member, the outer peripheral surface of the valve body, and the inner peripheral surface of the housing member.

4. The valve mechanism according to claim 1,
wherein a seat member-side cross-sectional area that includes the outer peripheral surface of the seat member, the inner peripheral surface of the housing member, and an extension line extending in an outer peripheral direction, that is perpendicular to the axial direction, from the seat section, and that is provided in a direction along the axial direction, is formed to be greater than a valve body-side cross-sectional area that includes the outer peripheral surface of the valve body, the inner peripheral surface of the housing member, and the extension line, and that is provided in a direction along the axial direction.

5. The valve mechanism according to claim 4,
wherein a size of the seat member-side cross-sectional area in the axial direction is formed to be greater than the size of the valve body-side cross-sectional area in the axial direction.

6. The valve mechanism according to claim 1,
wherein, the second fluid flow-path is formed on the outer peripheral side of the seat member, or formed along a full circumference of the valve body on the outer peripheral side.

7. The valve mechanism according to claim 1,
wherein, a stepped portion that is recessed inwardly is formed on the outer peripheral side of the seat member, and the stepped portion allows a valve body retaining member to be inserted without riding on the seat member.

8. A valve mechanism comprising:
a valve body;
a seat member having a seat section that comes in contact with the valve body; and
a housing member configured to retain the seat member on an outer peripheral side of the seat member,
wherein, on the outer peripheral surface of the seat member, a seat member slope is formed to expand toward the outer peripheral side in a direction from the valve body toward the seat member, and
a gap is formed between the slope and the housing member.

9. The valve mechanism according to claim 8,
wherein, on the outer peripheral surface of the seat member, a flat portion is formed to be substantially parallel with the inner peripheral surface of the housing member, on the side closer to the valve body more than the seat member slope, and a gap is formed between the flat portion and the housing member.

10. The valve mechanism according to claim 8,
wherein the valve body is configured to have a valve body slope to be expanding from the seat member toward the outer peripheral side along the direction toward the valve body on the outer peripheral side of the contact surface with the seat section,
a gap is formed between the valve body slope and the housing member, and
an inclination angle formed by the contact surface and both end portions of the seat member slope is greater than an inclination angle formed by the contact surface and both end portions of the valve body slope.

11. The valve mechanism according to claim 8,
wherein, on the outer peripheral surface of the seat member, a flat portion is formed to be substantially parallel with the inner peripheral surface of the housing member, on the side opposite to the valve body more than the seat member slope, and the housing member retains the seat member by coming in contact with the flat portion.

12. The valve mechanism according to claim 11,
wherein, the outer peripheral surface of the seat member is configured such that a recess is formed on an inner peripheral side further opposite to the side of the valve body, on the flat portion, and a gap is formed between the recess and the housing member.

13. The valve mechanism according to claim 8,
wherein the seat member slope is formed to be inclined to the outer peripheral side from the end portion of the flat portion of the seat section.

14. The valve mechanism according to claim 8,
wherein the seat member slope is formed in a tapered shape.

15. A high-pressure fuel supply pump comprising:
a pressurizing chamber configured to pressurize fuel; and
a discharge valve configured to discharge the fuel pressurized in the pressurizing chamber,
wherein the valve mechanism according to claim 1 is attached as the discharge valve.

16. A high-pressure fuel supply pump comprising:
a pressurizing chamber configured to pressurize fuel; and
a discharge valve configured to discharge the fuel pressurized in the pressurizing chamber,
wherein the valve mechanism according to claim 2 is attached as the discharge valve.

17. A high-pressure fuel supply pump comprising:
a pressurizing chamber configured to pressurize fuel; and
a discharge valve configured to discharge the fuel pressurized in the pressurizing chamber,
wherein the valve mechanism according to claim 8 is attached as the discharge valve.
